(19) United States
(12) Patent Application Publication
(10) Pub. No.: US 2025/0336578 A1
(43) Pub. Date: Oct. 30, 2025

(54) R-T-B MAGNET AND PREPARATION METHOD

(71) Applicants: BEIJING ZHONG KE SAN HUAN HI-TECH CO., LTD., Beijing (CN); SANVAC (BEIJING) MAGNETICS CO., LTD., Beijing (CN)

(72) Inventors: Bin FANG, Beijing (CN); Fei DU, Beijing (CN); E NIU, Beijing (CN); Haojie WANG, Beijing (CN)

(21) Appl. No.: 19/017,004

(22) Filed: Jan. 10, 2025

(30) Foreign Application Priority Data
Apr. 25, 2024 (CN) 202410509345.3

(51) Int. Cl. H01F 1/057; B22F 3/16; B22F 3/24; B22F 9/02; B22F 9/04; C22C 38/00; C22C 38/06; C22C 38/10; C22C 38/14; C22C 38/16; C23C 24/10; H01F 41/02

(52) U.S. Cl. CPC H01F 1/0577; B22F 3/16; B22F 3/24; B22F 9/023; B22F 9/04; C22C 38/002; C22C 38/005; C22C 38/06; C22C 38/10; C22C 38/14; C22C 38/16; C23C 24/106; H01F 41/0293; B22F 2003/242; B22F 2003/247; B22F 2003/248; B22F 2009/044; B22F 2201/02; B22F 2201/11; B22F 2201/20; B22F 2202/05; B22F 2301/355; B22F 2304/10; B22F 2998/10; B22F 2999/00; C22C 2202/02

(57) ABSTRACT

An R-T-B based magnet includes R, Fe, and B. R includes light and heavy rare earth elements. The heavy rare earth element includes terbium and/or dysprosium. The R-T-B based magnet includes main phase grains and an intergranular phase situated between the main phase grains. The main phase grains include grains that exhibit a core-shell structure. Along a diffusion direction of the heavy rare earth element from a surface to an interior of the R-T-B based magnet, in a microstructure observation surface within a region extending 200 μm inward from the surface of the R-T-B based magnet, an average heavy rare earth element content RH1 in the shell of the core-shell structure and an average heavy rare earth element content RH2 in the intergranular phase satisfy: RH1−RH2≥2.6 wt % and/or RH1/RH2≥21.5. The microstructure observation surface is perpendicular to the diffusion direction of the heavy rare earth element.

### CROSS-REFERENCE TO RELATED APPLICATION

This application claims priority to Chinese Application No. 202410509345.3, filed on Apr. 25, 2024, the entire content of which is incorporated herein by reference.

### TECHNICAL FIELD

This disclosure relates to the field of R-T-B magnet materials and, in particular, to a high-performance R-T-B magnet and preparation method thereof.

### BACKGROUND

The NdFeB rare earth permanent magnet represents the most potent magnetic material identified to date and has found extensive applications across various sectors due to its superior magnetic properties. With ongoing advancements in manufacturing technologies and heightened environmental awareness, it has garnered significant attention in the domains of energy conservation, environmental protection, renewable energy, and electric vehicles. Coercivity is a critical parameter for assessing the magnetic characteristics of permanent magnets. The heavy rare earth elements dysprosium (Dy) and terbium (Tb) are pivotal for enhancing coercivity, as they can effectively increase the anisotropy constants of the primary magnetic phase. However, their market prices are very high. Currently, the conventional approach to enhance coercivity involves the deposition and diffusion of heavy rare earth elements Dy and Tb onto the substrate surface, which serves to mitigate the manufacturing costs of the magnets. Nonetheless, the concentration of these heavy rare earth elements experiences a significant gradient, decreasing markedly from the surface to the interior of the magnet, resulting in a shallow diffusion depth and consequently limited performance enhancement. Particularly, the fabrication of magnets that exhibit high residual induction (Br), high coercivity (e.g., intrinsic coercivity, Hcj), and high squareness with reduced heavy rare earth content poses considerable challenges.

The mere inclusion of certain content in the background section does not constitute an admission by the applicant that such content is prior art.

### SUMMARY

The purpose of the present disclosure is to provide an R-T-B based magnet exhibiting enhanced magnetic properties while minimizing the content of heavy rare earth elements.

To accomplish the aforementioned objectives, this application provides an R-T-B based magnet, which comprises R element, Fe element, and B element, where the R element includes light rare earth elements and heavy rare earth elements, and the heavy rare earth element includes terbium and/or dysprosium elements;

wherein heavy rare earth elements diffuse from the surface into the interior of the R-T-B

based magnet which comprises main phase grains and an intergranular phase situated between these main phase grains, wherein the main phase grains include grains that exhibit a core-shell structure; and

wherein the average heavy rare earth element content RH1 of the shell in the core-shell structure and the average heavy rare earth element content RH2 of the intergranular phase satisfy: RH1−RH2>2.6 wt % and/or RH1/RH2≥1.5, along the diffusion direction of the heavy rare earth elements, at a microstructure observation surface within a region that extends 200 μm inward from the surface of the R-T-B based magnet, where the microstructure observation surface is perpendicular to the diffusion direction of the heavy rare earth elements.

In some embodiments, the proportion of the number of grains exhibiting a core-shell structure on the microstructure observation surface is no less than 90%, within a region of 500 μm inward from the surface of the R-T-B based magnet along the diffusion direction of the heavy rare earth elements.

In some embodiments, the heavy rare earth element content of the shell of the core-shell structure is higher than the heavy rare earth element content of the core of the core-shell structure, and the average heavy rare earth element content RH1 of the shell of the core-shell structure is no less than 2.0 wt %, within the 500 μm region from the surface along the diffusion direction of the heavy rare earth elements.

Further, in some embodiments, the area of the microstructure observation surface is limited to a maximum of 40,000 μm², and optionally to a maximum of 2,500 μm².

The microstructure observation surface may be configured as either a square or rectangular shape.

In some embodiments, the composition of the R-T-B based magnet is (PrNd)₂₇₋₂₉Dy_{0-0.65}Tb_{0-1.2}Ga_{0.1-0.65}Co_{0.3-3.05}Cu_{0.05-0.55}B_{0.90-0.98}A_{0.05-0.35}Al_{0-0.25}Fe_{bal}, wherein A comprises at least one element selected from titanium (Ti), zirconium (Zr), and niobium (Nb).

Moreover, in some embodiments, the remanence (Br) of the R-T-B based magnet is at least 14.2 kGs, the intrinsic coercivity (HcJ) is at least 27 kOe, and the ratio of knee point coercivity (Hk) to intrinsic coercivity (HcJ) is no less than 94%.

The second aspect of this application outlines a method for preparing the R-T-B based magnet, which includes the following steps:

applying a diffusion source alloy onto the surface of a substrate; performing diffusion heat treatment and tempering on the substrate, which is coated with the aforementioned diffusion source alloy;

wherein, the diffusion source alloy comprises a first heavy rare earth element, which includes terbium and/or dysprosium, and wherein the substrate includes light rare earth elements, second heavy rare earth elements, iron elements, and boron elements, where the second heavy rare earth elements include terbium and/or dysprosium;

the diffusion heat treatment includes a first stage heat treatment, a second stage heat treatment, and a cooling treatment conducted between the two stages, the first stage heat treatment entails maintaining a temperature of 820° C. to 850° C. under vacuum for a duration of 4 to 8 hours, and the cooling treatment involves cooling the assembly to below 100° C. in an inert atmosphere, while the second stage heat treatment involves holding at a temperature of 900° C. to 950° C. under vacuum for a period of 20 to 24 hours;

the tempering process includes adjusting the temperature to 460° C. to 500° C. under vacuum, followed by introducing inert gas to achieve a pressure of 70 kPa to 90 kPa, and maintaining this condition for a duration of 8 to 12 hours.

In some embodiments, the composition of the diffusion source alloy is represented as RH′ₐCo_{b}Al_{c}Cu_{d}Gaₑ, wherein RH′ denotes the first heavy rare earth element, a is in the range of 70 to 90 wt %, b is in the range of 0 to 10 wt %, c is in the range of 0 to 10 wt %, d is in the range of 0 to 10 wt %, and e is in the range of 0 to 10 wt %.

In some embodiments, the composition of the substrate is (PrNd)₂₇₋₂₉Dy_{0-0.5}Tb_{0-0.6}Ga_{0.1-0.6}Co_{0.3-3}Cu_{0.05-0.5}B_{0.90-0.98}A_{0.05-0.35}Al_{0-0.2}Fe_{bal}, where A comprises at least one element selected from titanium (Ti), zirconium (Zr), and niobium (Nb).

In some embodiments, the application of the diffusion source alloy onto the surface of the substrate is accomplished using at least one of the following methods: coating, vacuum deposition, and sputtering.

In some embodiments, the weight gain of the substrate is measured to be within the range of 0.3 to 0.6 wt % following the application of the diffusion source alloy onto the substrate surface.

In some embodiments, the diffusion source alloy is deposited onto the surface of the substrate through processes such as vacuum evaporation and/or sputtering, resulting in a diffusion alloy layer thickness of approximately 5 μm to 10 μm on the substrate surface.

In some embodiments, the diffusion source alloy is exclusively adhered to the diffusion surface of the substrate.

Further, in some embodiments, the coating method encompasses at least one of the following techniques: impregnation, spraying, and roll coating. The materials utilized in the coating comprise the diffusion source alloy, a binder, and a solvent, wherein the mass ratio of the diffusion source alloy to the binder ranges from 90:5 to 95:10.

The preparation method may further include the following steps:
preparing alloy strip;
grinding the alloy strip into alloy powder;
compressing the alloy powder into a compact;
sintering the compact to yield a sintered body; and
machining the sintered body to produce the substrate.

In certain embodiments, the preparation of alloy strip entails melting and casting the raw materials to obtain the alloy strip. The layer spacing of the neodymium-rich phase within the alloy strip is maintained at less than 3 μm.

In specific examples, the alloy powder has a particle size D₅₀ ranging from 3.5 to 3.8 μm, a D90/D10 ratio ranging from 4 to 4.6. The density of the compact in some examples is established to be within the range of 4 to 4.3 g/cm³.

In various implementation examples, the sintering temperature is between 1030° C. and 1050° C., with a holding time of 5 to 8 hours. The density of the resulting sintered body is determined to be between 7.55 and 7.58 g/cm³, with an average grain size ranging from 5.2 to 5.8 μm.

In the R-T-B based magnet disclosed in the present application, the diffusion depth of heavy rare earth elements is relatively significant, resulting in excellent magnetic performance. The present application employs a diffusion heat treatment under vacuum conditions, followed by tempering treatment conducted under a controlled inert atmospheric pressure. This methodology facilitates the deep diffusion of heavy rare earth elements into the substrate, thereby yielding R-T-B based magnets having a low content of heavy rare earth elements while maintaining superior magnetic properties.

The additional aspects and advantages of the present disclosure will be described in detail below, and will become evident from the subsequent description, or may be understood through the practice of the present disclosure.

### BRIEF DESCRIPTION OF DRAWINGS

The diagrams included in this disclosure are provided to enhance the understanding of the present disclosure. The illustrative embodiments and their descriptions herein are intended to elucidate the present disclosure and do not impose any undue limitations thereon.

FIG. 1 illustrates the process flow diagram for the preparation of a high-performance R-T-B based magnet as provided in one embodiment of the present application.

FIG. 2 presents a process flow diagram for the preparation of a high-performance R-T-B based magnet as provided in another embodiment of the present application.

FIGS. 3A to 3E are scanning electron micrographs of the R-T-B based magnet prepared in Embodiment 1 of the present application.

FIGS. 4A to 4E are scanning electron micrographs of R-T-B based magnets prepared in Comparative Embodiment 1 of the present application.

### DETAILED DESCRIPTION OF EMBODIMENTS

The following text presents exemplary implementations of the disclosure. Those skilled in the art will recognize that various modifications may be made to the described embodiments without departing from the spirit or scope of the disclosure. Accordingly, the figures and descriptions provided herein are intended to be exemplary and not limiting.

In consideration of the measurements discussed and the associated errors inherent in the measurement of specific quantities (i.e., the limitations of the measurement system), the use of terms such as “about” or “approximately” herein encompasses the stated values and implies a range of acceptable deviations from a specific value as determined by skilled technical personnel in the field. For instance, “about” may indicate a variation within one or more standard deviations, or within ±30%, ±20%, ±10%, or ±5% of the stated value.

This application discloses a high-performance R-T-B based magnet. In the context of the R-T-B based magnet, “R” denotes a rare earth element, “T” represents iron (Fe), and “B” represents boron (B). The R-T-B based magnet as described in this application comprises rare earth elements, iron, and boron. The rare earth element “R” encompasses both light rare earth elements (RL) and heavy rare earth elements (RH). The heavy rare earth elements include terbium (Tb) and/or dysprosium (Dy).

Additionally, the R-T-B based magnet may optionally include an “M” element, wherein the “M” element comprises one or more of gallium (Ga), cobalt (Co), copper (Cu), titanium (Ti), aluminum (Al), zirconium (Zr), and niobium (Nb).

The composition of the R-T-B based magnet may optionally be as follows: (PrNd)₂₇₋₂₉Dy_{0-0.65}Tb_{0-1.2}Ga_{0.1-0.65}Co_{0.3-3.05}Cu_{0.05-0.55}B_{0.90-0.98}A_{0.05-0.35}Al_{0-0.25}Fe_{bal}, where “A” encompasses at least one element selected from titanium (Ti), zirconium (Zr), and niobium (Nb), and “bal” is abbreviation of “balance” and means the residual amount. The ratios of each element are expressed in weight percentages.

In the present application, heavy rare earth elements are described to diffuse from the surface into the interior of R-T-B magnet. The R-T-B magnet comprise main phase grains and a grain boundary phase situated between the main phase grains. The main phase grains include grains that exhibit a core-shell structure, characterized as grains formed subsequent to the diffusion of heavy rare earth elements within the R-T-B magnet.

Within this application, along the diffusion direction of heavy rare earth elements, within a region extending 200 μm inward from the surface of the R-T-B based magnet, the average content of heavy rare earth elements in the shell (designated as RH1) of the core-shell structure and the average content in the grain boundary phase (designated as RH2) must satisfy the following conditions: RH1−RH2≥2.6 wt % and/or RH1/RH2≥1.5. Thus, it can be observed that, even at low overall concentrations of heavy rare earth elements (not exceeding 1.2 wt %), there remains a significant concentration of heavy rare earth elements after diffusing 200 μm in depth distance. Furthermore, these heavy rare earth elements are predominantly concentrated within the main phase grains, with comparatively lower concentrations in the grain boundary phase, thereby enhancing the performance characteristics of the R-T-B based magnets. The average content of heavy rare earth elements is determined by calculating the mean concentration of one or more heavy rare earth elements in a minimum of 10 core-shell structured primary phase grain cores, shells, and adjacent grain boundary phases that are observable on the microstructure observation surface. In some embodiments, this average is derived from the total heavy rare earth element content across all core-shell structured primary phase grain cores, shells, and adjacent grain boundary phases.

In particular implementation embodiments, the difference between RH1 and RH2 (RH1−RH2) may vary within the range of 2.6 to 4.0 wt %, with specific values including 2.6 wt %, 2.8 wt %, 3.0 wt %, 3.2 wt %, 3.4 wt %, 3.6 wt %, 3.8 wt %, or 4.0 wt %. Additionally, the ratio of RH1 to RH2 (RH1/RH2) may range from 1.5 to 2, with specific examples of 1.5, 1.55, 1.6, 1.65, 1.7, 1.75, 1.8, 1.85, 1.9, 1.95, or 2.

The diffusion direction of heavy rare earth elements within R-T-B magnet is predominantly from the surface toward the interior; however, this direction is not necessarily aligned with the linear path connecting the surface to the center of the R-T-B magnet. The term “microstructure observation surface,” as utilized in this application, pertains to scanning images of R-T-B magnet acquired through electron microscopy techniques, including but not limited to scanning electron microscopy (SEM) and transmission electron microscopy (TEM). In accordance with this application, the microstructure observation surface is oriented perpendicular to the diffusion direction of the heavy rare earth elements, thereby facilitating a more intuitive examination of the diffusion phenomena.

The microstructure observation surface positioned within a region of 200 μm inward from the surface of the R-T-B based magnet may encompass one or multiple observation surfaces.

In a preferred embodiment, within the diffusion direction of heavy rare earth elements and within a 500 μm depth region from the surface of R-T-B based magnets, the proportion of grains exhibiting a core-shell structure on the microstructure observation surface is equal to or greater than 90%. This proportion may range from 91% to 96%. Specific embodiments may present the proportion of grains with a core-shell structure as 91%, 91.5%, 92%, 92.5%, 93%, 93.5%, 94%, 94.5%, 95%, 95.5%, or 96%, indicating that a significant concentration of heavy rare earth elements is maintained even after diffusion over a distance of 500 μm.

Additionally, along the diffusion direction of heavy rare earth elements, within the microstructure observation surface located 500 μm inward from the surface of R-T-B based magnets, it is observed that the concentration of heavy rare earth elements in the shell of the core-shell structure exceeds that in the core of the same structure. This finding confirms that, in the grain structure resulting from the diffusion of heavy rare earth elements, the heavy rare earth element content in the shell consistently surpasses that in the core.

Moreover, within the aforementioned 500 μm region from the surface of the R-T-B based magnet, the average concentration of heavy rare earth elements in the shell of the core-shell structure is designated as RH1≥2.0 wt %. This observation further indicates that, even following a diffusion distance of 500 μm, heavy rare earth elements retain a relatively elevated concentration within the shell of the grains.

The microstructure observation surface located 500 μm inward from the surface of the R-T-B based magnet may comprise one or more regions. In some embodiments, the size (area) of the microstructure observation surface is less than or equal to 40,000 μm², and more in some embodiments, less than or equal to 2,500 μm². The microstructure observation surface may have a square or rectangular configuration. In specific embodiments, the microstructure observation surface is square, with dimensions of 50 μm×50 μm or 100 μm×100 μm. In other specific embodiments, the microstructure observation surface is rectangular, with dimensions of 50 μm×100 μm or 100 μm×200 μm. The preferred dimension is 50 μm×50 μm, which is considered moderate in size and facilitates the observation of the diffusion of rare earth elements.

In the R-T-B based magnets disclosed herein, despite the low content of heavy rare earth elements, the diffusion depth of said elements is substantial, resulting in excellent magnet performance. The remanence (Br) of the R-T-B based magnets is optionally greater than or equal to 14.2 kGs, the intrinsic coercivity (HcJ) is optionally greater than or equal to 27 kOe, and the ratio of knee coercivity (Hk) to intrinsic coercivity (Hk/HcJ) is optionally greater than or equal to 94%.

In specific implementation examples, the Br of the R-T-B based magnet can range from 14.3 kGs to 14.6 kGs, including but not limited to values such as 14.3 kGs, 14.32 kGs, 14.35 kGs, 14.38 kGs, 14.4 kGs, 14.43 kGs, 14.45 kGs, 14.47 kGs, 14.5 kGs, 14.52 kGs, 14.54 kGs, 14.56 kGs, 14.58 kGs, or 14.6 kGs.

In certain implementation examples, the HcJ of the R-T-B magnet can vary from 27 kOe to 29 kOe, including values such as 27 kOe, 27.2 kOe, 27.4 kOe, 27.6 kOe, 27.8 kOe, 28 kOe, 28.2 kOe, 28.4 kOe, 28.6 kOe, 28.8 kOe, or 29 kOe.

In other specific implementation examples, the Hk/HcJ ratio of the R-T-B based magnet can range from 94% to 99%, with possible values including 94%, 94.5%, 95%, 95.5%, 96%, 96.5%, 97%, 97.5%, 98%, 98.5%, or 99%.

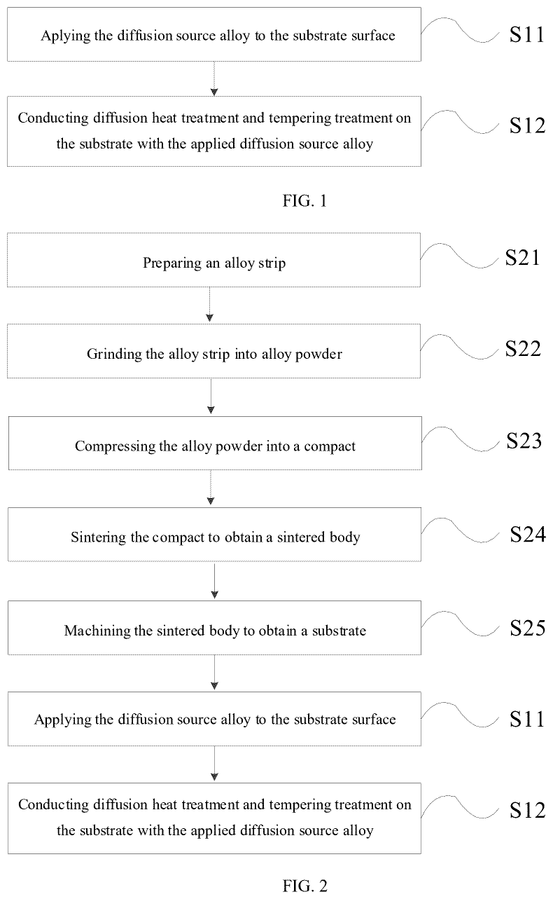

FIG. 1 illustrates a preparation method for a high-performance R-T-B based magnet as disclosed in an embodiment of this application, comprising the step S11 of applying the diffusion source alloy to the substrate surface, and the step S12 of conducting diffusion heat treatment and tempering treatment on the substrate with the applied diffusion source alloy.

Attaching the diffusion source alloy to the substrate surface, wherein the diffusion source alloy comprises a first heavy rare earth element, which may include terbium and/or dysprosium.

Optionally, the substrate material may contain light rare earth elements, second heavy rare earth elements, iron, and boron. Light rare earth elements may include praseodymium (Pr) in addition to neodymium (Nd). The second heavy rare earth elements may also include terbium and/or dysprosium. The substrate may further incorporate M elements, where M elements may comprise one or more of gallium, cobalt, copper, titanium, aluminum, zirconium, and niobium. In this context, the first and second heavy rare earth elements may be identical or distinct.

Optionally, the substrate composition is as follows: (PrNd)₂₇₋₂₉Dy_{0-0.5}Tb_{0-0.6}Ga_{0.1-0.6}Co_{0.3-3}Cu_{0.05-0.5}B_{0.90-0.98}A_{0.05-0.35}Al_{0-0.2}Fe_{bal}, wherein A includes at least one of the elements titanium (Ti), zirconium (Zr), and niobium (Nb). The ratios of each element are expressed in weight percentages.

Optionally, the composition of the diffusion source alloy is represented as RH′ₐCo_{b}Al_{c}Cu_{d}Gaₑ, wherein RH′ represents the first heavy rare earth element, and the value ranges of the parameters a, b, c, d, and e are as follows: a=70-90 wt %, b=0-10 wt %, c=0-10 wt %.

Alternatively, at least one of the diffusion source alloys may be deposited onto the substrate surface utilizing methods such as coating, vacuum deposition, or sputtering. In this context, the term “coating” encompasses techniques including, but not limited to, impregnation, spray coating, and roll coating. These methodologies are well-established in the relevant technical field, and specific operational details are not elaborated upon herein.

Optionally, when the diffusion source alloy is applied to the substrate surface using a coating method, a slurry comprising the diffusion source alloy, a binder, and a solvent may be deposited on the substrate surface. It is further optional that, upon completion of the coating process, the weight gain of the substrate is in the range of 0.3 to 0.6 wt %. The term “weight gain” as used herein refers to the ratio of the weight of the heavy rare earth elements present in the diffusion source alloy coated on the substrate surface to the weight of the substrate following the application of the slurry. For illustrative purposes, if the weight of the heavy rare earth elements in the slurry applied to the substrate surface is 0.4 g, and the weight of the substrate is 100 g, the resultant weight gain would be 0.4 wt %. In specific embodiments, the weight gain may be 0.3 wt %, 0.35 wt %, 0.4 wt %, 0.45 wt %, 0.5 wt %, 0.55 wt %, or 0.6 wt %.

Optionally, the mass ratio of the diffusion source alloy to the binder in the slurry is in the range of (90-95):(5-10). It is further optional that the binder comprises polyvinyl butyral (PVB) and that the solvent is an alcohol.

When the diffusion source alloy is deposited on the surface of the substrate using methods such as vacuum evaporation or sputtering, a diffusion alloy layer may be formed on the substrate surface. Optionally, the thickness of the diffusion alloy layer is in the range of 5-10 μm. In certain specific embodiments, the thickness of the diffusion alloy layer may be 5 μm, 5.5 μm, 6 μm, 6.5 μm, 7 μm, 7.5 μm, 8 μm, 8.5 μm, 9 μm, 9.5 μm, or 10 μm. Furthermore, when the diffusion source alloy is deposited on the substrate surface utilizing methods such as vacuum evaporation or sputtering, the amount of diffusion source alloy may also be quantified in terms of the additional weight, without the need for further elaboration.

Optionally, the diffusion source alloy is applied solely to the diffusion surface of the substrate, thereby ensuring the minimal use of the diffusion source alloy. It is noted that while the quantity of the diffusion source alloy in this application is relatively small, the diffusion depth of the heavy rare earth elements is significantly pronounced.

Conducting diffusion heat treatment and tempering treatment on the substrate with the attached diffusion source alloy.

In this application, the diffusion heat treatment comprises three stages: a first-stage heat treatment, a second-stage heat treatment, and a cooling treatment performed between the first-stage and second-stage heat treatments. The first-stage heat treatment involves adjusting the temperature to a range of 820° C. to 850° C. under vacuum conditions and maintaining this temperature for a period of 4 to 8 hours. The cooling treatment entails cooling the substrate to below 100° C. in an inert atmosphere. The second-stage heat treatment involves adjusting the temperature to a range of 900° C. to 950° C. under vacuum conditions and holding this temperature for a duration of 20 to 24 hours. Optionally, in this application, argon (Ar) gas may be utilized as the inert gas during the cooling treatment.

In certain specific implementation examples, the temperature of the first-stage heat treatment may be set to 820° C., 825° C., 830° C., 835° C., 840° C., 845° C., or 850° C., while the holding time may range from 4 hours to 8 hours, including increments of 0.5 hours (e.g., 4 hours, 4.5 hours, 5 hours, 5.5 hours, 6 hours, 6.5 hours, 7 hours, 7.5 hours, or 8 hours).

In additional specific implementation examples, the cooling process may cool the substrate, following the first-stage heat treatment, to temperatures of 98° C., 95° C., 92° C., 90° C., 85° C., or 80° C.

In further specific implementation examples, the temperature of the second-stage heat treatment may be set to 900° C., 905° C., 910° C., 915° C., 920° C., 925° C., 930° C., 935° C., 940° C., 945° C., or 950° C., with the holding time ranging from 20 hours to 24 hours, including increments of 0.5 hours (e.g., 20 hours, 20.5 hours, 21 hours, 21.5 hours, 22 hours, 22.5 hours, 23 hours, 23.5 hours, or 24 hours).

In this application, the tempering process includes adjusting the temperature to a range of 460° C. to 500° C. under vacuum conditions, followed by the introduction of an inert gas to achieve a pressure of 70 kPa to 90 kPa, and maintaining this temperature for a duration of 8 to 12 hours. Specifically, the substrate, subsequent to diffusion heat treatment, is first heated to a temperature within the range of 460° C. to 500° C. under vacuum, then filled with inert gas to a pressure of 70 kPa to 90 kPa, and held for a period of 8 to 12 hours. Optionally, argon (Ar) gas may be utilized as the inert gas during the tempering process.

In some specific implementation examples, the temperature for the heat treatment may be set to 460° C., 465° C., 470° C., 475° C., 480° C., 485° C., 490° C., 495° C., or 500° C., the pressure may be set to 70 kPa, 72 kPa, 75 kPa, 78 kPa, 80 kPa, 83 kPa, 85 kPa, 87 kPa, or 90 kPa, and the holding time may be from 8 hours to 12 hours, including increments of 0.5 hours (e.g., 8 hours, 8.5 hours, 9 hours, 9.5 hours, 10 hours, 10.5 hours, 11 hours, 11.5 hours, or 12 hours).

Optionally, the cumulative duration of the annealing time for both the diffusion heat treatment and the tempering treatment may range from 35 to 40 hours. In certain specific embodiments, the total annealing time for both processes may be 35 hours, 35.5 hours, 36 hours, 36.5 hours, 37 hours, 37.5 hours, 38 hours, 38.5 hours, 39 hours, 39.5 hours, or 40 hours.

This application leverages diffusion heat treatment conducted in vacuum conditions and tempering treatment performed under controlled inert gas pressure to facilitate the deeper diffusion of heavy rare earth elements into the substrate, thereby yielding an R-T-B based magnet having a reduced content of heavy rare earth elements while exhibiting superior magnetic properties.

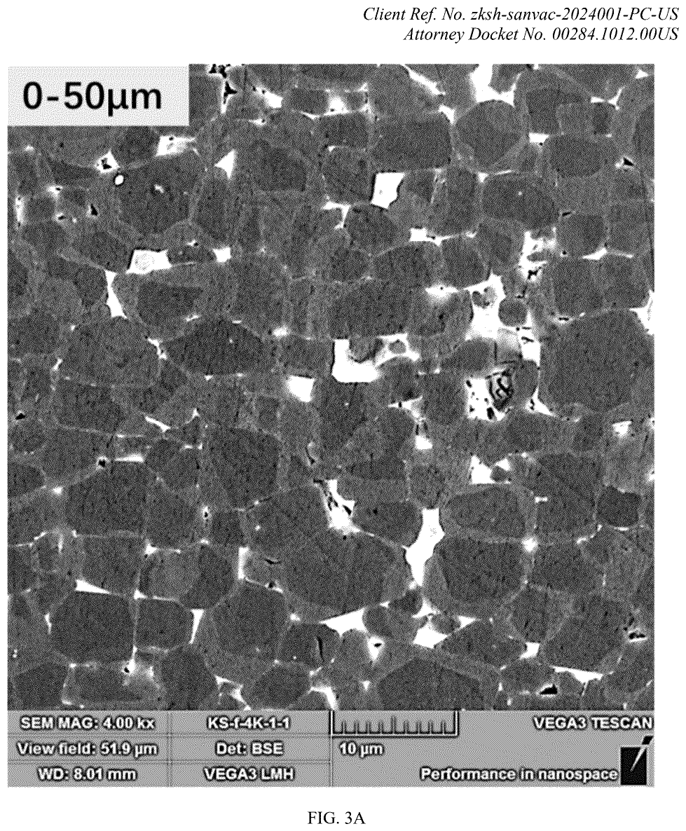

FIG. 2 illustrates a method for preparing a high-performance R-T-B based magnet, as described in another embodiment of the present application. This method comprises the step S21 of preparing alloy strips through the step S25 of sintering the compact to obtain the sintered body, in addition to the previously mentioned steps S11 and S12, which are not repeated herein.

The details of steps S21 to S25 are set forth below.

### Preparing Alloy Strips

The composition of the alloy strips is identical to that of the aforementioned substrate. The alloy strip composition may be (PrNd)₂₇₋₂₉Dy_{0-0.5}Tb_{0-0.6}Ga_{0.1-0.6}Co_{0.3-3}Cu_{0.05-0.5}B_{0.90-0.98}A_{0.05-0.35}Al_{0-0.2}Fe_{bal}, where A comprises at least one element selected from Ti, Zr, and Nb. The alloy raw materials are to be prepared, including Pr—Nd, DyFe, industrial Fe—B, industrial pure Fe, 99.9% pure Co, Cu, Ti, Ga, Tb, Al, Zr, Nb, and other metals, in accordance with the specified alloy composition.

Following the preparation of the materials, the process of melting is conducted. The prepared materials are placed into a high-frequency vacuum induction melting furnace, evacuated to approximately 10⁻² Pa, heated, and subsequently melted. Thereafter, the rapidly cooled alloy strips are cast onto copper rolls at temperatures ranging from 1480° C. to 1520° C. Optionally, the distance between the neodymium-rich phase layers within the alloy strips is maintained at less than 3 μm.

Additionally, the thickness of the alloy strip may range from 0.2 mm to 0.3 mm. In certain specific embodiments, the thickness of the alloy strip may be selected from 0.2 mm, 0.22 mm, 0.24 mm, 0.26 mm, 0.28 mm, or 0.3 mm. Maintaining a spacing of less than 3 μm between the neodymium-rich phases in the alloy strip facilitates the diffusion of terbium elements in subsequent processing steps.

Crushing the alloy strip into alloy powder.

In this step, it is optionally proposed to first perform coarse crushing the strip piece by hydrogen decrepitation process, followed fine pulverizing by jet milling. The process involves placing the alloy strips in a hydrogen decrepitation furnace at

room temperature, evacuating the furnace, and subsequently introducing hydrogen gas to maintain a pressure of approximately 0.2 MPa. After achieving sufficient hydrogen absorption, drawing a vacuum while heating to about 540° C. is performed, followed by maintaining the vacuum for 10 hours. The resulting powder is extracted after crushing of the hydrogen decrepitation.

Subsequently, the crushed powder is processed in a nitrogen atmosphere with an oxygen content of less than 100 ppm, utilizing gas jet milling at pressures ranging from 0.6 MPa to 0.8 MPa in the crushing chamber to obtain the alloy powder. The median particle size (D₅₀) of the alloy powder is optionally between 3.5 μm and 3.8 μm, with specific examples including 3.5 μm, 3.55 μm, 3.6 μm, 3.65μ, 3.7 μm, 3.75 μm, or 3.8 μm. Additionally, the ratio of D₉₀/D₁₀ corresponding to the cumulative particle size distribution reaching 90% and 100% is optionally between 4.0 and 4.6, with specific embodiments including 4.0, 4.1, 4.2, 4.3, 4.4, 4.5, or 4.6. The alloy powder obtained through this process exhibits a small particle size and a relatively uniform particle size distribution.

Pressing the alloy powder into a compact.

In this step, it is conducted under a molding pressure of 15 MPa to 20 MPa in a magnetic field orientation of not less than 1.8 T. Specific molding pressures can include 15 MPa, 16 MPa, 17 MPa, 18 MPa, 19 MPa, or 20 MPa. The bulk density of the compact is optionally between 4 g/cm³ and 4.3 g/cm³, with specific embodiments including 4 g/cm³, 4.05 g/cm³, 4.1 g/cm³, 4.15 g/cm³, 4.2 g/cm³, 4.25 g/cm³, or 4.3 g/cm³.

Sintering the compact to obtain the sintered body.

In this step, it is performed at temperatures ranging from 1030° C. to 1050° C. for a duration of 5 to 8 hours, followed by cooling to room temperature in an inert gas atmosphere (e.g., argon) to obtain the sintered body. Specific sintering temperatures can include 1030° C., 1035° C., 1040° C., 1045° C., or 1050° C., with holding times of 5 hours, 5.5 hours, 6 hours, 6.5 hours, 7 hours, 7.5 hours, or 8 hours.

The sintered body has a density range of 7.55 to 7.58 g/cm³ and an average grain size ranging from 5.2 to 5.8 μm. In specific embodiments, the density of the sintered body may be 7.55 g/cm³, 7.56 g/cm³, 7.57 g/cm³, or 7.58 g/cm³. Additionally, the average grain size of the sintered body may be 5.2 μm, 5.3 μm, 5.4 μm, 5.5 μm, 5.6 μm, 5.7 μm, or 5.8 μm.

This application employs a low-temperature, long-duration sintering method for the sintering of the green body, resulting in favorable grain size characteristics.

Processing the sintered body to obtain a substrate.

The processing of the sintered body is carried out in accordance with actual requirements. Subsequent to processing, the substrate is subjected to a cleaning operation, as described herein.

The preparation method disclosed in this application facilitates the production of R-T-B based magnets exhibiting high magnetic performance while maintaining a low content of heavy rare earth elements.

The following examples are provided to illustrate the present disclosure. The process conditions and numerical values presented in the examples and comparative examples are intended for illustrative purposes only. The ranges of numerical values can be as disclosed in the description of the disclosure. For any process parameters not explicitly mentioned, it is to be understood that conventional techniques may be employed. Unless otherwise specified, reagents and instruments utilized in the technical solutions provided by the present disclosure are obtainable from conventional sources or the market. It is noteworthy that, in the absence of contradictions, the features of the examples in the present application may be combined with each other. The testing methods employed in the following examples and comparative examples are recognized experimental methods within this technical field unless specifically stated otherwise.

### Implementation Example 1

This embodiment pertains to the preparation of a high-performance R-T-B based magnet, with the specific steps outlined as follows:

Preparing Pr—Nd, DyFe, industrial Fe—B, industrial pure Fe, 99.9% purity Co, Cu, Ti, Ga, Tb, and other metals according to the alloy ratio specified in Table 1. Introducing the prepared raw materials into an alumina crucible and conducting vacuum melting at a temperature of approximately 1480° C. within a high-frequency vacuum induction melting furnace, under a vacuum of about 10⁻² Pa.

Injecting Ar gas into the vacuum melting furnace, followed by casting the NdFeB alloy strips using a single roller quenching method, thereby achieving a cooling rate of around 4×10³° C./s. Notably, the interlayer spacing of the rich Nd phase in the alloy sheet is maintained below 3 μm, with an average thickness of approximately 0.25 mm.

Establishing a vacuum in the hydrogen decrepitation furnace containing the rapidly cooled alloy at room temperature, then introducing hydrogen gas into the hydrogen decrepitation furnace while maintaining the hydrogen gas pressure at approximately 0.2 MPa. Allowing sufficient hydrogen absorption, followed by drawing a vacuum while raising the temperature to about 540° C., and subsequently cooling for 10 hours. The crushed powder from the hydrogen decrepitation furnace is then removing. Conducting gas-jet milling of the crushed powder in a nitrogen atmosphere with an oxygen gas content below 100 ppm, under a pressure of about 0.6 MPa for several hours, to obtain alloy powder. The D₅₀ of the alloy powder is approximately 3.7 μm, and the D_{90/}D₁₀ ratio is about 4.55.

Adding methyl caprylate to the pulverized powder, at an addition amount of about 0.1 wt % relative to the weight of the mixed powder, and mixing thoroughly using a V-type mixer.

Forming the powder mixed with methyl caprylate in one step using a square-oriented magnetic field forming machine, under an orientation magnetic field of not less than 1.8 T and a forming pressure of about 18 MPa, followed by demagnetizing the formed body in a magnetic field of approximately 0.2 T to obtain a green body. The density of the green body is about 4.1 g/cm³.

Transferring each compact to the sintering furnace for sintering. The sintering process is

conducted under a vacuum of approximately 10⁻¹ Pa, maintaining each sample at temperatures of approximately 400° C. and 800° C. for about 2 hours each, subsequently sintering at a temperature of about 1050° C. for about 3 hours. Ar gas is then introducing to achieve a pressure of about 0.1 MPa, followed by cooling to room temperature. The density of the sintered body is as approximately 7.55 g/cm^{3,} with an average grain size of about 5.3 μm.

Machining the sintered body to form a substrate with dimensions of 10 mm in length, 7.5 mm in thickness, and 7.62 mm in height, with the height direction serving as the orientation for the magnetic field. Subsequently, the magnet undergoes a degreasing and cleaning process, excluding pickling. The properties of the substrate are detailed in Table 2.

Preparing the diffusion source alloy, Tb90Co5Al5 alloy powder is mixed with a binder (PVB) and alcohol to create a slurry. This slurry is then coated onto the upper and lower surfaces of the substrate, ensuring that the side surfaces (front, back, left, and right) remain uncoated. Following the coating process, the substrate exhibits a weight gain of approximately 0.6 wt %.

The substrate, now affixed with the diffusion source alloy, is placed in an atmospheric furnace. The furnace is evacuated, and the temperature is adjusted to approximately 820° C. in a vacuum, maintaining this temperature for about 6 hours. Subsequently, argon gas is introduced into the furnace, and the substrate is cooled to approximately 95° C. in an argon atmosphere. The furnace is then evacuated again, and the temperature is raised to about 900° C., where it is held for approximately 24 hours. The temperature is then adjusted to about 480° C., and argon gas is introduced to achieve a pressure of approximately 70 kPa, maintaining this condition for about 10 hours.

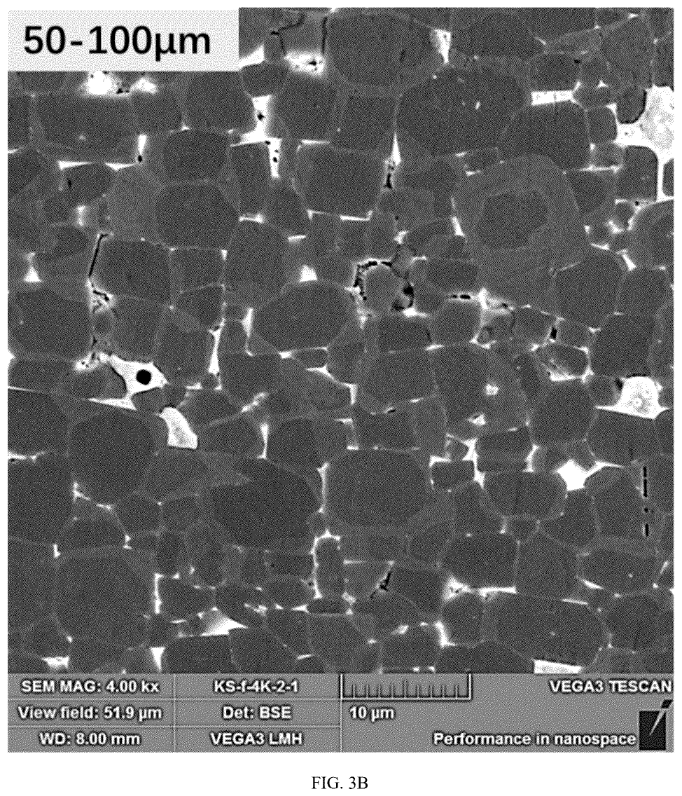

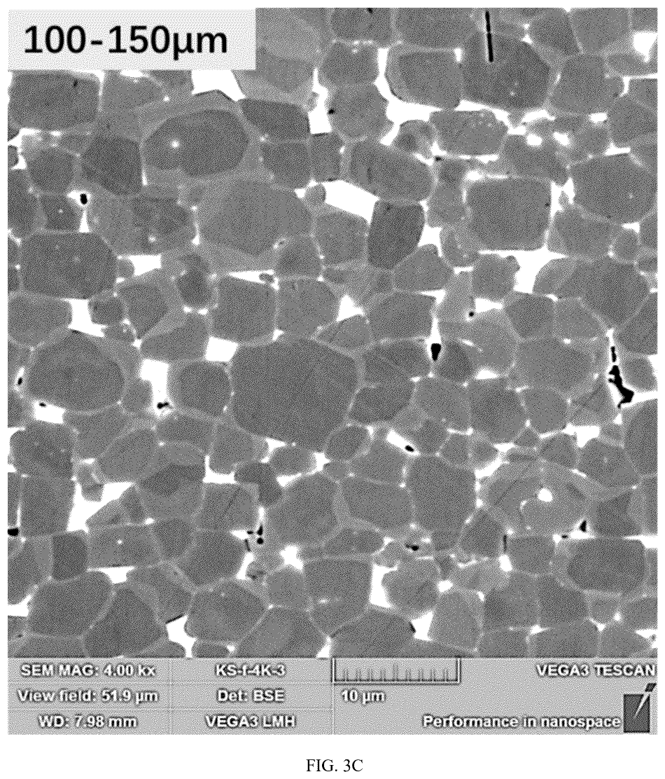

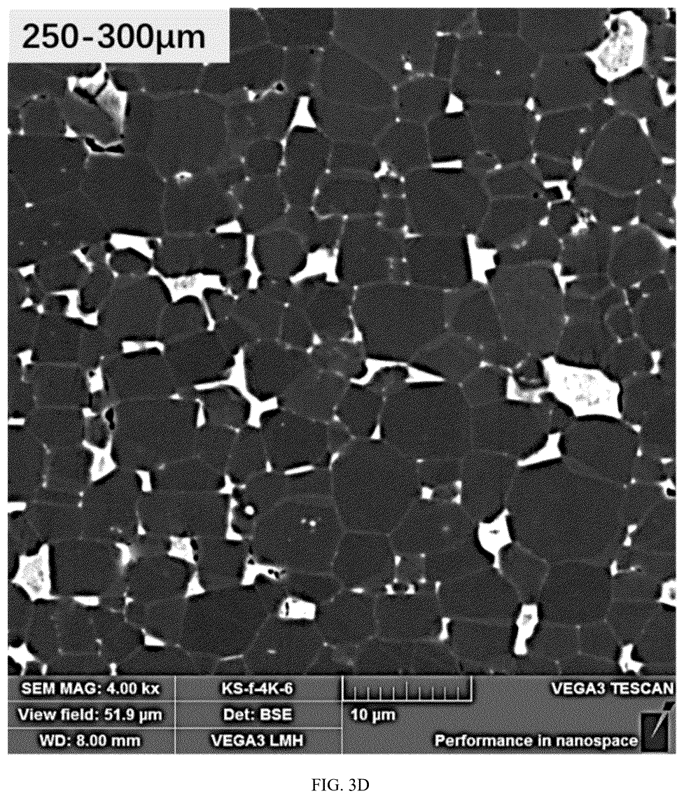

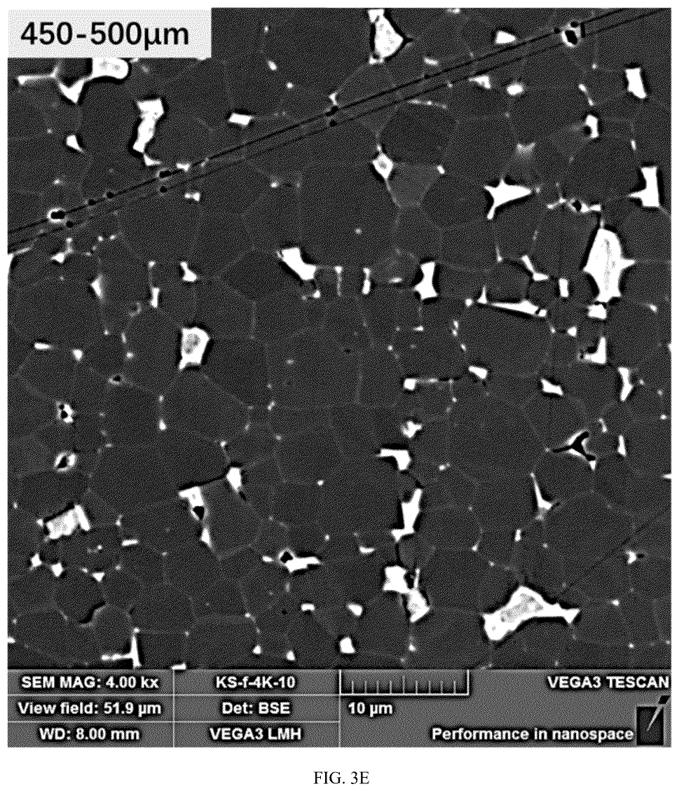

The compositions of the R-T-B based magnet elements, as determined by ICP detection, are presented in Table 2. The performance characteristics of the R-T-B based magnet are detailed in Table 3. Table 4 illustrates the distribution of terbium elements within the core-shell structured grains and grain boundaries of the R-T-B based magnet. Scanning electron micrographs depicting the diffusion direction of the terbium element are shown in FIGS. 3A to 3E, representing regions at depths of 0-50 μm, 50-100 μm, 100-150 μm, 250-300 μm, and 450-500 μm inward from the surface of the R-T-B based magnet. The area for microstructure observation is 50 μm×50 μm.

### Implementation Example 2

The distinction between this implementation and Implementation 1 resides in the application of sputtering for attaching the diffusion source alloy to the surface of the substrate.

The thickness of the resultant diffusion alloy layer measures approximately 8 μm, and the weight increase amounts to about 0.6 wt %.

The composition of the base alloy is detailed in Table 1, the composition of the obtained R-T-B based magnets is provided in Table 2, and the magnet performance is outlined in Table 3.

### Implementation Example 3

The distinction between this implementation and Example 1 resides in the differing proportions of alloy elements, as presented in Table 1. The composition of the obtained R-T-B based magnet is provided in Table 2, and the magnet performance is outlined in Table 3.

### Implementation Example 4

This implementation differs from Example 3 in that tempering occurs at a pressure of approximately 89 kPa. The composition of the base material alloy is detailed in Table 1, the composition of the obtained R-T-B based magnet is shown in Table 2, and the magnet performance is summarized in Table 3.

### Implementation Example 5

The difference between this embodiment and Example 1 lies in the composition of the diffusion source alloy, which is Dy₁₀Tb₇₅Co₁₀Al₂Cu₂Ga₁. The composition of the substrate alloy is shown in Table 1, the composition of the obtained R-T-B based magnet is provided in Table 2, and the magnet performance is detailed in Table 3.

### Implementation Example 6

The distinction between this embodiment and Example 1 is that the diffusion source alloy comprises Dy₁₀Tb₇₅Co₁₀Al₂Ga₃. The alloy ratio of the substrate is presented in Table 1, the composition of the obtained R-T-B based magnet is shown in Table 2, and the magnet performance is outlined in Table 3.

### Comparison 1

The difference from Example 1 resides in the specific steps of the diffusion annealing and tempering treatments. The substrate containing the diffusion source alloy is placed into a vacuum furnace, followed by evacuation of the furnace. The temperature within the vacuum is adjusted to approximately 820° C. and maintained for about 6 hours. Subsequently, the temperature in the furnace is increased to approximately 900° C. and held for about 24 hours. The temperature in the furnace is then adjusted to approximately 480° C. under vacuum and held for about 10 hours.

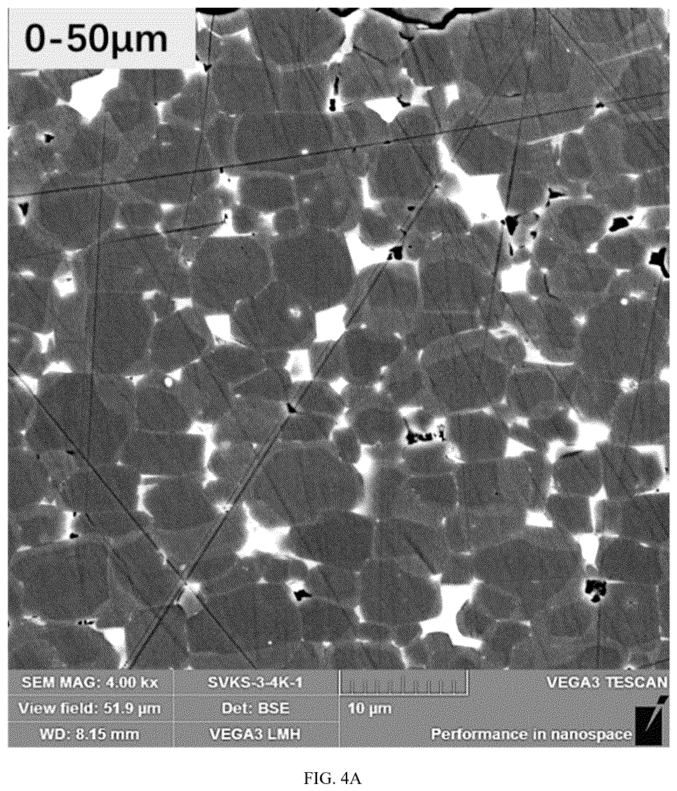

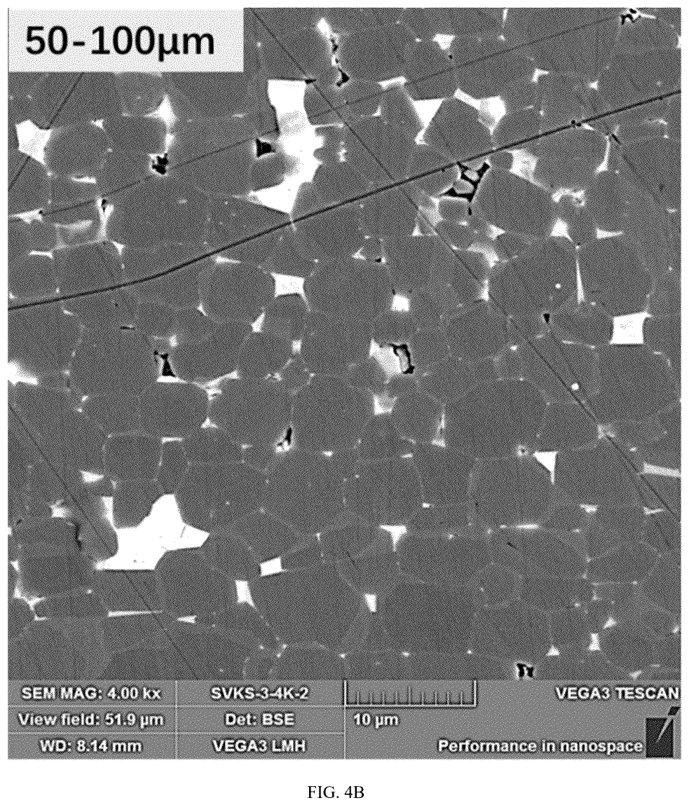

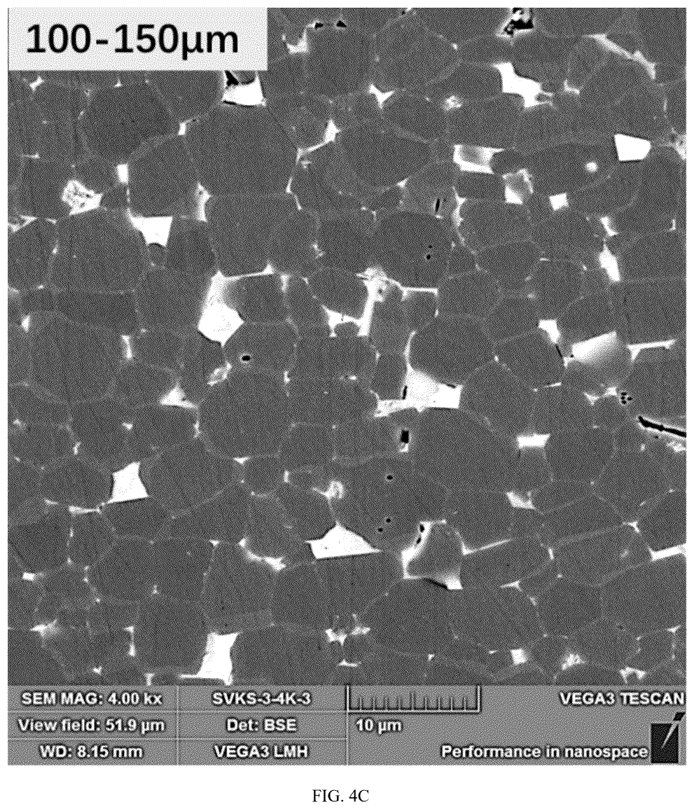

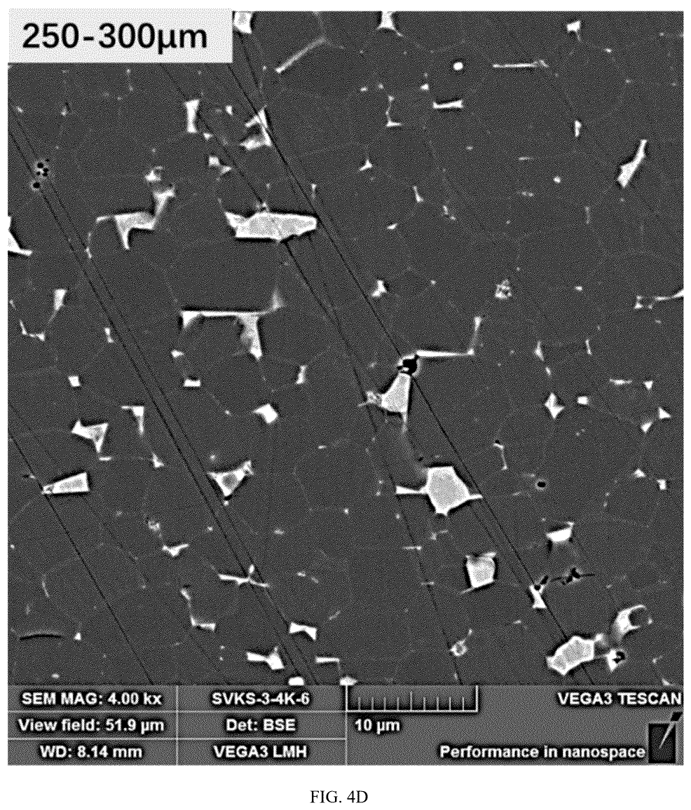

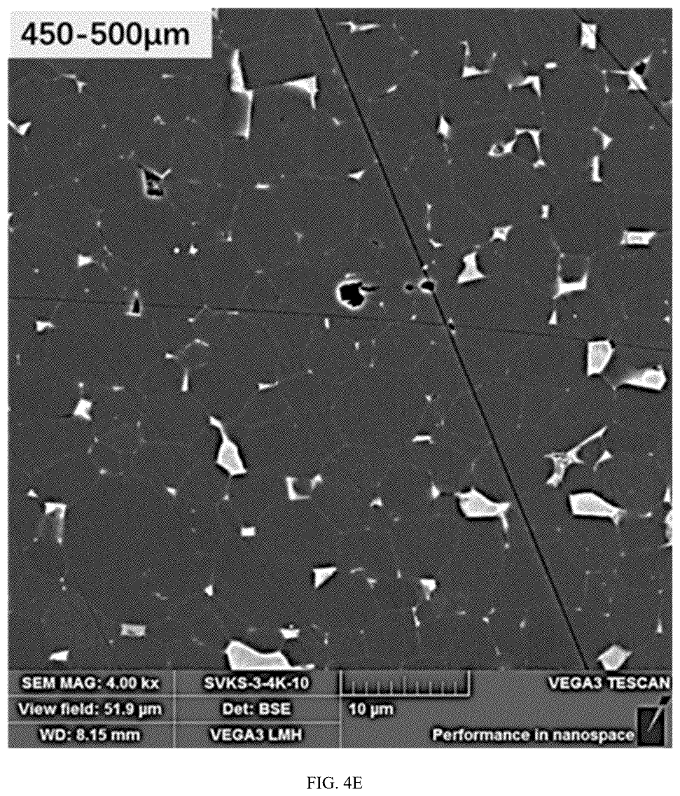

The composition of the base alloy is shown in Table 1, the composition of the obtained R-T-B based magnet is provided in Table 2, and the magnet performance is detailed in Table 3. Table 5 presents the distribution of terbium elements within the core-shell structure of the R-T-B based magnet obtained in this comparison. FIGS. 4A to 4E depict scanning electron micrographs illustrating the direction of terbium diffusion at depths of 0-50 μm, 50-100 μm, 100-150 μm, 250-300 μm, and 450-500 μm inward from the surface of the R-T-B based magnet. The microscopic observation surface has dimensions of 50 μm×50 μm.

Presenting the composition of the base alloy in Table 1, displaying the composition of the R-T-B based magnet obtained in Table 2, and showing the magnet performance in Table 3. Table 5 illustrates the distribution of terbium elements within the core-shell structure of the R-T-B based magnet obtained in this ratio comparison. FIGS. 4A to 4E depict scanning electron micrographs illustrating the direction of terbium diffusion at depths of 0-50 μm, 50-100 μm, 100-150 μm, 250-300 μm, and 450-500 μm inward from the surface of the R-T-B based magnet. The microscopic observation surface is also in the shape of 50 μm×50 μm.

### Comparison 2

The specific steps of the tempering process deviate from those outlined in Example 1, as follows:

Upon completion of the diffusion heat treatment, the substrate is placed in a vacuum chamber, wherein the temperature within the furnace is adjusted to approximately 480° C. Subsequently, argon (Ar) gas is introduced into the chamber, achieving a pressure of approximately 60 kPa. This temperature and pressure are maintained for a duration of approximately 10 hours.

The composition of the base alloy is detailed in Table 1, while the composition of the resulting R-T-B based magnets is presented in Table 2. The magnet performance metrics are provided in Table 3.

### Comparison 3

The specific steps of the tempering process differ from those described in Example 1 as follows:

Upon completion of the diffusion heat treatment, the temperature within the furnace is adjusted to approximately 480° C. under vacuum conditions. The furnace is then filled with argon (Ar) gas to a pressure of approximately 100 kPa and maintained at this temperature for a duration of approximately 10 hours.

The composition of the base alloy is detailed in Table 1, while the composition of the resulting R-T-B based magnets is presented in Table 2. The magnet performance metrics are provided in Table 3.

TABLE 1

| | Pr—Nd | Dy | Tb | B | Co | Cu | Ga | Ti | Fe |
|---|---|---|---|---|---|---|---|---|---|
| Example1 | 29 | 0.5 | 0.3 | 0.97 | 0.6 | 0.06 | 0.2 | 0.12 | Balance |
| Example2 | 29 | 0.5 | 0.3 | 0.97 | 0.6 | 0.06 | 0.2 | 0.12 | Balance |
| Example3 | 28.5 | 0 | 0.6 | 0.95 | 1 | 0.12 | 0.15 | 0.1 | Balance |
| Example4 | 28.5 | 0 | 0.6 | 0.95 | 1 | 0.12 | 0.15 | 0.1 | Balance |
| Example5 | 29 | 0.5 | 0.3 | 0.97 | 0.6 | 0.06 | 0.2 | 0.12 | Balance |
| Example6 | 29 | 0.5 | 0.3 | 0.97 | 0.6 | 0.06 | 0.2 | 0.12 | Balance |
| Compar- | 29 | 0.5 | 0.3 | 0.97 | 0.6 | 0.06 | 0.2 | 0.12 | Balance |
| ison1 | | | | | | | | | |
| Compar- | 29 | 0.5 | 0.3 | 0.97 | 0.6 | 0.06 | 0.2 | 0.12 | Balance |
| ison2 | | | | | | | | | |
| Compar- | 29 | 0.5 | 0.3 | 0.97 | 0.6 | 0.06 | 0.2 | 0.12 | Balance |
| ison3 | | | | | | | | | |

TABLE 2

| | Pr—Nd | Dy | Tb | B | Co | Cu | Ga | Ti | Al | Fe |
|---|---|---|---|---|---|---|---|---|---|---|
| Example1 | 28.8 | 0.48 | 0.75 | 0.97 | 0.61 | 0.06 | 0.18 | 0.12 | 0.01 | Balance |
| Example2 | 28.8 | 0.48 | 0.75 | 0.96 | 0.61 | 0.06 | 0.18 | 0.12 | 0.01 | Balance |
| Example3 | 28.7 | 0 | 1.13 | 0.95 | 1.01 | 0.06 | 0.17 | 0.12 | 0.01 | Balance |
| Example4 | 28.8 | 0 | 1.16 | 0.95 | 1.01 | 0.06 | 0.18 | 0.12 | 0.01 | Balance |
| Example5 | 28.6 | 0.54 | 0.70 | 0.95 | 0.64 | 0.06 | 0.18 | 0.12 | 0.01 | Balance |
| Example6 | 28.7 | 0.55 | 0.69 | 0.96 | 0.63 | 0.06 | 0.19 | 0.12 | 0.01 | Balance |
| Compar- | 28.8 | 0.48 | 0.75 | 0.97 | 0.61 | 0.06 | 0.18 | 0.12 | 0.01 | Balance |
| ison1 | | | | | | | | | | |
| Compar- | 28.8 | 0.48 | 0.75 | 0.97 | 0.61 | 0.06 | 0.18 | 0.12 | 0.01 | Balance |
| ison2 | | | | | | | | | | |
| Compar- | 28.8 | 0.48 | 0.75 | 0.97 | 0.61 | 0.06 | 0.18 | 0.12 | 0.01 | Balance |
| ison3 | | | | | | | | | | |

TABLE 3

| | | Bᵣ (kGS) | H_{cJ} (kOe) | Hₖ/H_{cJ} |
|---|---|---|---|---|
| Example1 | Substrate | 14.52 | 16.5 | 0.97 |
| | R-T-B BASED | 14.25 | 27.55 | 0.954 |
| | MAGNET | | | |
| Example2 | R-T-B BASED | 14.23 | 27.35 | 0.962 |
| | MAGNET | | | |
| Example3 | Substrate | 14.6 | 17.05 | 0.98 |
| | R-T-B BASED | 14.32 | 28.05 | 0.965 |
| | MAGNET | | | |
| Example4 | R-T-B BASED | 14.33 | 27.98 | 0.962 |
| | MAGNET | | | |
| Example5 | R-T-B BASED | 14.27 | 28.32 | 0.945 |
| | MAGNET | | | |
| Example6 | R-T-B BASED | 14.21 | 27.06 | 0.952 |
| | MAGNET | | | |
| Comparison1 | R-T-B BASED | 14.22 | 27.13 | 0.958 |
| | MAGNET | | | |
| Comparison2 | R-T-B BASED | 14.26 | 27.31 | 0.896 |
| | MAGNET | | | |
| Comparison3 | R-T-B BASED | 14.25 | 27.28 | 0.912 |
| | MAGNET | | | |

TABLE 4

| Depth of | | | | |
|---|---|---|---|---|
| diffusion of the | | | | |
| Terbium element | | | | |
| from the surface | | | | |
| of the R-T-B | | | | |
| based magnet | | | | |
| towards the | | | RH1 − RH2 | |
| interior (μm) | RH1 (wt %) | RH2 (wt %) | (wt %) | RH1/RH2 |
| 0~50 | 8.9 | 5.7 | 3.25 | 1.57 |
| 50~100 | 7.6 | 4.9 | 2.66 | 1.54 |
| 100~150 | 8.0 | 4.1 | 3.96 | 1.97 |
| 150~200 | 6.0 | 3.1 | 2.95 | 1.96 |
| 200~250 | 4.1 | 3.6 | 0.51 | 1.14 |
| 250~300 | 4.4 | 2.9 | 1.49 | 1.51 |
| 300~350 | 2.9 | 2.6 | 0.33 | 1.13 |
| 350~400 | 2.5 | 3.6 | −1.05 | 0.71 |
| 400~450 | 3.5 | 2.6 | 0.86 | 1.33 |
| 450~500 | 2.2 | 2.9 | −0.68 | 0.76 |

TABLE 5

| Depth of | | | | |
|---|---|---|---|---|
| diffusion of the | | | | |
| Terbium element | | | | |
| from the surface | | | | |
| of the R-T-B | | | | |
| based magnet | | | | |
| towards the | | | RH1 − RH2 | |
| interior (μm) | RH1 (wt %) | RH2 (wt %) | (wt %) | RH1/RH2 |
| 0~50 | 7.0 | 4.2 | 2.73 | 1.64 |
| 50~100 | 4.8 | 4.5 | 0.30 | 1.06 |
| 100~150 | 3.8 | 3.4 | 0.38 | 1.11 |
| 150~200 | 4.9 | 2.6 | 2.31 | 1.87 |
| 200~250 | 4.1 | 2.7 | 1.37 | 1.50 |
| 250~300 | 1.7 | 2.4 | −0.63 | 0.73 |
| 300~350 | 2.6 | 2.8 | −0.13 | 0.95 |
| 350~400 | 3.1 | 2.3 | 0.84 | 1.37 |
| 400~450 | 2.0 | 2.4 | −0.44 | 0.82 |
| 450~500 | 1.3 | 2.4 | −1.09 | 0.55 |

From Tables 4 and 5, it is evident that in the R-T-B based magnet produced in Example 1, the diffusion depth of the terbium element can reach at least 500 μm. Within this depth range, the concentration of the terbium element in the core-shell structured grains formed by the diffusion is also significantly high. In contrast, in the R-T-B based magnet produced in the first comparison, although the diffusion depth of the terbium element is also relatively deep, the concentration of the terbium element in the core-shell structured grains formed by the diffusion is comparatively low, and the diffusion uniformity is inadequate.

From FIGS. 3A to 3E, it is observed that with a gadolinium diffusion depth of 500 μm, the R-T-B based magnet obtained in Example 1 maintains a high proportion of gadolinium diffusion forming core-shell structured grains, exceeding 90%. From FIGS. 4A to 4E, it is apparent that compared to the magnet produced in Example 1, with a gadolinium diffusion depth of 150 μm, the proportion of core-shell structured grains formed by gadolinium diffusion is relatively high. However, as the diffusion depth increases to approximately 300 μm and 500 μm, the proportion of core-shell structured grains formed by gadolinium diffusion diminishes, particularly at 500 μm, where the proportion is only about 30%. Furthermore, within the diffusion depth range of 0-500 μm for the magnet obtained in Example 1, RH1 consistently exceeds 2.0 wt %.

Clearly, the aforementioned implementation examples are illustrative of the present disclosure and are not intended to limit the embodiments. Skilled artisans in the relevant field may make various changes or modifications based on the above description. It is neither necessary nor possible to exhaust all potential embodiments. Obvious changes or modifications derived therefrom remain within the scope of the present disclosure.

1. An R-T-B based magnet comprising:
R element, Fe element, and B element;
wherein:
the R element includes a light rare earth element and a heavy rare earth element, and the heavy rare earth element includes terbium element and/or dysprosium element;
the R-T-B based magnet includes main phase grains and an intergranular phase situated between the main phase grains, the main phase grains including grains that exhibit a core-shell structure;
along a diffusion direction of the heavy rare earth element from a surface of the R-T-B based magnet to an interior of the R-T-B based magnet, in a microstructure observation surface within a region that extends 200 μm inward from the surface of the R-T-B based magnet, an average heavy rare earth element content RH1 in the shell of the core-shell structure and an average heavy rare earth element content RH2 in the intergranular phase satisfy:
RH1-RH2≥2.6 wt % and/or RH1/RH2≥1.5; and
the microstructure observation surface is perpendicular to the diffusion direction of the heavy rare earth element.

2. The R-T-B based magnet according to claim 1, wherein:
along the diffusion direction of the heavy rare earth element, in a microstructure observation surface within a region that extends 200 μm inward from the surface of the R-T-B based magnet, a proportion of a number of grains exhibiting the core-shell structure is no less than 90%.

3. The R-T-B based magnet according to claim 2, wherein, along the diffusion direction of the heavy rare earth element, in a microstructure observation surface within a region that extends 200 μm inward from the surface of the R-T-B based magnet:
a heavy rare earth element content of the shell of the core-shell structure is higher than a heavy rare earth element content of the core of the core-shell structure; and
an average heavy rare earth element content of the shell of the core-shell structure is no less than 2.0 wt %.

4. The R-T-B based magnet according to claim 1, wherein:
an area of the microstructure observation surface is smaller than or equal to 40,000 μm².

5. The R-T-B based magnet according to claim 1, wherein:
the microstructure observation surface has a square or rectangular shape.

6. The R-T-B based magnet according to claim 1, wherein:
a composition of the R-T-B based magnet is (PrNd)₂₇₋₂₉Dy_{0-0.65}Tb_{0-1.2}Ga_{0.1-0.65}Co_{0.3-3.05}Cu_{0.05-0.55}B_{0.90-0.98}A_{0.05-0.35}Al_{0-0.25}Fe_{bal}, wherein A includes at least one element selected from titanium (Ti), zirconium (Zr), and niobium (Nb).

7. The R-T-B based magnet according to claim 6, wherein:
a remanence of the R-T-B based magnet is at least 14.2 kGs;
an intrinsic coercivity of the R-T-B based magnet is at least 27 kOe; and
a ratio of a knee point coercivity of the R-T-B based magnet to the intrinsic coercivity of the R-T-B based magnet is no less than 94%.

8. A method for preparing the R-T-B based magnet according to claim 1, comprising:
applying a diffusion source alloy onto a surface of a substrate; and
performing diffusion heat treatment and tempering on the substrate coated with the diffusion source alloy;
wherein:
the diffusion source alloy includes a first heavy rare earth element including at least one of terbium or dysprosium;
the substrate includes a light rare earth element, a second heavy rare earth element, iron element, and boron element, the second heavy rare earth element including at least one of terbium or dysprosium;
the diffusion heat treatment includes:
a first stage heat treatment including maintaining a temperature of 820° C. to 850° C. under vacuum for a duration of 4 to 8 hours;
a cooling treatment after the first stage heat treatment and including cooling in an inert atmosphere to below 100° C.; and
a second stage heat treatment after the cooling treatment and including holding at a temperature of 900° C. to 950° C. under vacuum for a period of 20 to 24 hours; and
the tempering includes adjusting the temperature to 460° C. to 500° C. under vacuum, followed by introducing inert gas to achieve a pressure of 70 kPa to 90 kPa, and maintaining temperature for a duration of 8 to 12 hours.

9. The method according to claim 8, wherein:
a composition of the diffusion source alloy is RH′ₐCo_{b}Al_{c}Cu_{d}Gaₑ, where:
RH′ denotes the first heavy rare earth element,
a is in a range of 70 to 90 wt %,
b is in a range of 0 to 10 wt %,
c is in a range of 0 to 10 wt %,
d is in a range of 0 to 10 wt %, and
e is in a range of 0 to 10 wt %.

10. The method according to claim 8, wherein:
a composition of the substrate is (PrNd)₂₇₋₂₉Dy_{0-0.5}Tb_{0-0.6}Ga_{0.1-0.6}Co_{0.3-3}Cu_{0.05-0.5}B_{0.90-0.98}A_{0.05-0.35}Al_{0-0.2}Fe_{bal}, where A includes at least one element selected from titanium (Ti), zirconium (Zr), and niobium (Nb).

11. The method according to claim 8, wherein:
the diffusion source alloy is applied onto the surface of the substrate through at least one of coating, vacuum deposition, or sputtering.

12. The method according to claim 11, wherein:
the coating includes at least one of impregnation, spraying, or roll coating.

13. The method according to claim 12, wherein:
a material for the coating includes the diffusion source alloy, a binder, and a solvent; and
a mass ratio of the diffusion source alloy to the binder ranges from 90:5 to 95:10.

14. The method according to claim 11, wherein:
the diffusion source alloy is applied onto the surface of the substrate through coating; and
a weight gain of the substrate is within a range of 0.3 to 0.6 wt % after the diffusion source alloy is coated onto the substrate surface.

15. The method according to claim 11, wherein:
the diffusion source alloy is applied onto the surface of the substrate through at least one of vacuum evaporation or sputtering; and
a thickness of a diffusion alloy layer formed by the diffusion source alloy on the surface of the substrate is approximately 5 μm to 10 μm.

16. The method according to claim 8, further comprising:
preparing an alloy strip;
grinding the alloy strip into alloy powder;
compressing the alloy powder into a compact;
sintering the compact to obtain a sintered body; and
machining the sintered body to produce the substrate.

17. The method according to claim 16, wherein:
preparing the alloy strip includes melting and casting a raw material to obtain the alloy strip; and
a layer spacing of a neodymium-rich phase in the alloy strip is smaller than 3 μm.

18. The method according to claim 16, wherein:
the alloy powder has a particle size D₅₀ ranging from 3.5 to 3.8 μm, and a D₉₀/D₁₀ ratio ranging from 4 to 4.6.

19. The method according to claim 16, wherein:
a sintering temperature is between 1030° C. and 1050° C., with a holding time of 5 to 8 hours.

20. The method according to claim 16, wherein:
the sintered body has a density between 7.55 and 7.58 g/cm³, and an average grain size ranging from 5.2 to 5.8 μm.
